(19) United States
(12) Patent Application Publication
(10) Pub. No.: US 2025/0379485 A1
(43) Pub. Date: Dec. 11, 2025

(54) CIRCUIT-INTEGRATED MOTOR

(71) Applicant: MIKUNI CORPORATION, Tokyo (JP)

(72) Inventor: Naoki TANAKA, Odawara-shi (JP)

(21) Appl. No.: 19/186,910

(22) Filed: Apr. 23, 2025

(30) Foreign Application Priority Data
Jun. 6, 2024 (JP) 2024-091885

(51) Int. Cl. H02K 5/22; H02K 11/33

(52) U.S. Cl. CPC H02K 5/225; H02K 11/33; H02K 2211/03

(57) ABSTRACT

A circuit-integrated motor includes: a motor; a control board for controlling the motor; and a casing including a partition part dividing a board chamber for housing the control board from a placement space for the motor, and a cover disposed on the opposite side of the control board from the partition part. An opposing surface of the partition part to the control board includes: a non-contact region not in contact with the control board; and a contact region rising from the non-contact region and in contact with the control board. The cover has a protrusion which protrudes toward the board chamber at a position overlapping with the contact region of the opposing surface when viewed from the normal direction of the control board. The control board is held between the protrusion and the contact region of the opposing surface.

### TECHNICAL FIELD

The present disclosure relates to a circuit-integrated motor in which a motor and a control unit (control board) are integrated into a single module.

### BACKGROUND ART

Conventionally, a circuit-integrated motor has been known in which a motor and a control unit are integrated into a single module.

In a circuit-integrated motor, a control board is housed in a board chamber that is separated from a motor placement space by a partition part of a casing, and a motor coil wire is led through the partition part to the board chamber, where the coil wire is connected to the control board. The control board is typically fixed to the partition part with screws or other fastening parts.

Patent Document 1 describes a brushless motor in which a stator winding (coil wire) is led through a centerpiece (partition part) to a board chamber, and an end portion of the winding is connected to the circuit board (control board). The circuit board is fixed to the centerpiece with screws.

Citation List Patent Literature Patent Document 1: JP2018-93607A

### SUMMARY

However, for example as described in Patent Document 1, when the control board is fixed to the partition part with screws, the number of parts increases, as well as the man-hours required to process the screw holes and fasten the screws.

In view of the above, an object of at least some embodiments of the present invention is to provide a circuit-integrated motor capable of reducing the number of parts and the number of assembly man-hours.

A circuit-integrated motor according to at least some embodiments of the present invention includes: a motor; a control board for controlling the motor; and a casing including a partition part dividing a board chamber for housing the control board from a placement space for the motor, and a cover disposed on the opposite side of the control board from the partition part. An opposing surface of the partition part to the control board includes: a non-contact region not in contact with the control board; and a contact region rising from the non-contact region and in contact with the control board. The cover has at least one protrusion which protrudes toward the board chamber at a position overlapping with the contact region of the opposing surface when viewed from the normal direction of the control board. The control board is held between the at least one protrusion of the cover and the contact region of the opposing surface of the partition part.

According to at least some embodiments of the present invention, since the control board can be held and fixed by the protrusion of the cover that covers the control board in the board chamber, it is possible to simplify the fixing structure of the control board and reduce the number of man-hours required to assemble the circuit-integrated motor. Additionally, it is possible to reduce the number of fastening parts used to fix the control board and reduce the number of parts in the circuit-integrated motor.

### BRIEF DESCRIPTION OF DRAWINGS

FIG. 1A is a cross-sectional view schematically showing a configuration of a circuit-integrated motor according to an embodiment.

FIG. 1B is a cross-sectional view schematically showing a configuration of a circuit-integrated motor according to another embodiment.

FIG. 1C is a cross-sectional view schematically showing a configuration of a circuit-integrated motor according to still another embodiment.

FIG. 2 is a cross-sectional view of a circuit-integrated motor according to an embodiment, taken along its axial direction.

FIG. 3 is a perspective view of the circuit-integrated motor shown in FIG. 2, showing the internal structure of the board chamber with the cover and the sealing resin omitted.

FIG. 4 is a perspective view of the circuit-integrated motor shown in FIG. 2, showing the internal structure of the board chamber with the cover, the sealing resin, and a part of the control board omitted.

FIG. 5 is a perspective view of the cover of the circuit-integrated motor shown in FIG. 2, showing the cover from above at an angle.

FIG. 6 is a perspective view of the cover of the circuit-integrated motor shown in FIG. 2, showing the cover from below at an angle.

### DETAILED DESCRIPTION

Embodiments of the present invention will now be described in detail with reference to the accompanying drawings. It is intended, however, that unless particularly identified, dimensions, materials, shapes, relative positions, and the like of components described in the embodiments shall be interpreted as illustrative only and not intended to limit the scope of the present invention.

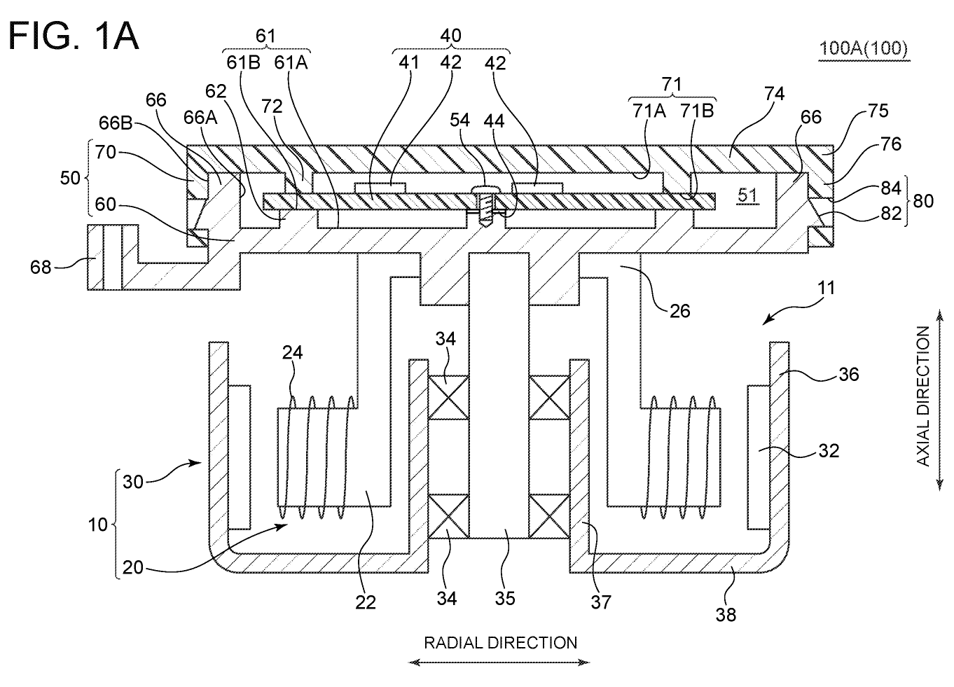

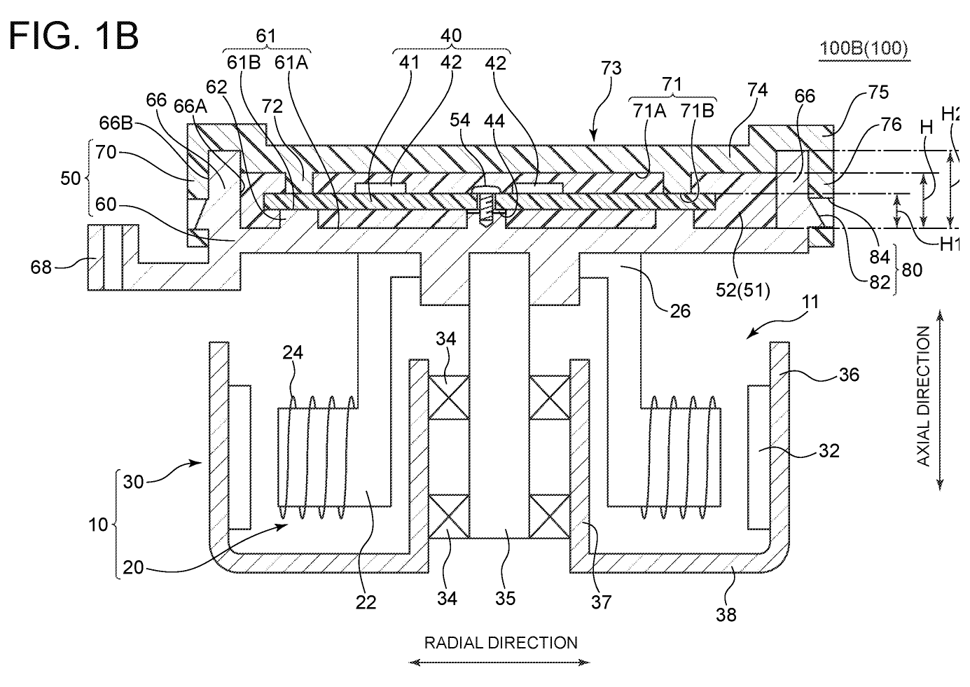

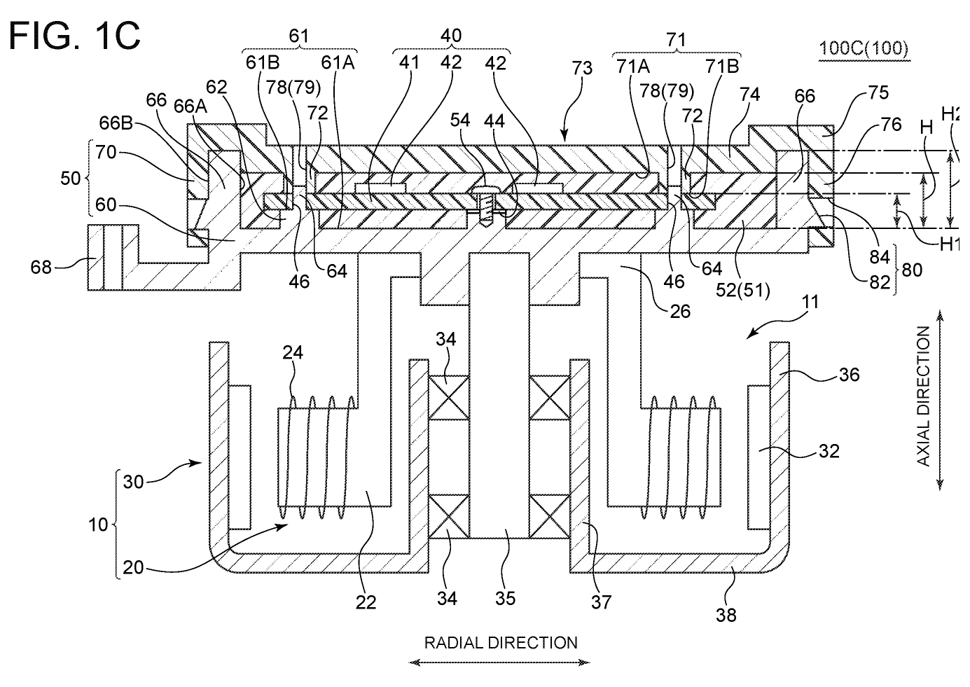

FIG. 1A is a cross-sectional view schematically showing a configuration of a circuit-integrated motor 100A according to an embodiment. FIG. 1B is a cross-sectional view schematically showing a configuration of a circuit-integrated motor 100B according to another embodiment. FIG. 1C is a cross-sectional view schematically showing a configuration of a circuit-integrated motor 100C according to still another embodiment.

Hereafter, when referring to various embodiments including at least one of FIGS. 1A, 1B and 1C, we will simply use the notation of “circuit-integrated motor 100,” or use the notation of “circuit-integrated motor 100 (100A),” “circuit-integrated motor 100 (100A, 100B),” or the like to clarify the encompassed embodiments.

As shown in FIGS. 1A to 1C, the circuit-integrated motor 100 includes a motor 10, a control board 40 for controlling the motor 10, and a casing 50 having a partition part 60 and a cover 70.

The control board 40 is covered by the casing 50. The casing 50 forms a board chamber 51 for housing the control board 40. The motor 10 is arranged in a motor placement space 11 on the opposite side of the partition part 60 from the board chamber 51.

In some embodiments, as shown in FIGS. 1A to 1C, the motor 10 includes a stator 20 including a stator core 22, and a rotor 30 having a magnet 32 disposed so as to face the stator core 22 in the radial direction. The stator core 22 is wound with a coil wire (stator coil) 24. The coil wire 24 is connected to the control board 40. When a current flows through the coil wire 24 via the control board 40, the rotor 30 rotates in the circumferential direction due to interaction between the magnet 32 and a magnetic field created by the coil wire 24.

Power supplied to the coil wire 24 of the stator 20 is controlled by an inverter circuit included in the control board 40.

In the embodiments shown in FIGS. 1A to 1C, the circuit-integrated motor 100 is an outer rotor motor in which the magnet 32 of the rotor 30 is located on the outer peripheral side of the stator core 22 of the stator 20.

Specifically, the stator 20 includes a stator core 22 wound with a coil wire 24, and a base part 26 fixed to the casing 50 (partition part 60, described below). The stator core 22 extends axially from the base part 26 in the direction opposite to the partition part 60 and extends radially outward toward the magnet 32 in the axial position corresponding to the magnet 32. The coil wire 24 is wound around the stator core 22 radially outward of the base part 26 of the stator 20.

In contrast, the rotor 30 is a rotating part that is rotatably mounted on a support shaft 35 via a bearing 34. The support shaft 35 is a stationary shaft that may be a part of the stator 20. The rotor 30 has a double cylindrical structure including an outer peripheral wall 36 and an inner peripheral wall 37, and the outer peripheral wall 36 and the inner peripheral wall 37 are connected to each other via a bottom wall 38. The magnet 32 is attached to an inner peripheral surface of the outer peripheral wall 36.

In another embodiment, the circuit-integrated motor 100 is an inner rotor motor in which the rotor 30 is located on the inner peripheral side of the stator 20. The inner rotor circuit-integrated motor 100 has the same basic configuration as the examples shown in FIGS. 1A to 1C, except for the positional relationship between the rotor 30 and the stator 20.

The control board 40 is housed in the board chamber 51 formed between the partition part 60 and the cover 70.

In some embodiments, as shown in FIGS. 1B and 1C, the board chamber 51 is filled with a sealing resin 52, and the control board 40 is embedded in the sealing resin 52. In contrast, in the embodiment shown in FIG. 1A, the board chamber 51 is a cavity.

The control board 40 includes a printed wiring board 41, and an electronic device 42 mounted on the printed wiring board 41.

The electronic device 42 may be a component of the inverter circuit for controlling power supplied to the coil wire 24 of the motor 10, and may be, for example, a semiconductor device represented by a FET. Alternatively, the electronic device 42 may be a passive element such as a capacitor or a coil.

In some embodiments, as shown in FIGS. 1A to 1C, the circuit-integrated motor 100 includes a screw 54 that fastens the control board 40 to the partition part 60, described below, and the control board 40 has a ground terminal 44 disposed in a portion that is fastened to the partition part 60 by the screw 54. The ground terminal 44 is disposed opposite the partition part 60 in the portion of the printed wiring board 41 that is fastened to the partition part 60 by the screw 54.

The ground terminal 44 is pressed against the partition part 60 having conductivity by fastening force of the screw 54 and is electrically connected to the partition part 60.

As shown in FIGS. 1A to 1C, the casing 50 that covers the control board 40 with the above configuration includes the partition part 60 dividing the board chamber 51 from the motor placement space 11. The partition part 60 extends along a direction (radial direction) perpendicular to the axial direction of the circuit-integrated motor 100. The contour of the partition part 60 in plan view is not particularly limited and may be, for example, defined by a curve, such as a circle or oval, or a polygon, such as a rectangle or square.

The material of the partition part 60 is not particularly limited. The partition part 60 may be composed of a conductive metal, for example, an aluminum alloy.

The partition part 60 has an opposing surface 61 to the control board 40, and the opposing surface 61 forms a part of the inner wall surface of the board chamber 51 (the bottom surface of the board chamber 51).

In some embodiments, as shown in FIGS. 1A to 1C, the opposing surface 61 of the partition part 60 includes a non-contact region 61A not in contact with the control board 40 and a contact region 61B rising from the non-contact region 61A and in contact with the control board 40.

In the embodiments shown in FIGS. 1A to 1C, the non-contact region 61A of the opposing surface 61 is a flat surface that faces the surface of the printed wiring board 41 of the control board 40 via a gap and is parallel to the surface of the printed wiring board 41. On the other hand, the contact region 61B of the opposing surface 61 is a top surface of a rising portion 62 of the partition part 60 and is a flat surface parallel to the surface of the printed wiring board 41 of the control board 40. The rising portion 62 of the partition part 60 rises toward the cover 70 with respect to the non-contact region 61A of the opposing surface 61.

In some embodiments, as shown in FIG. 1C, the partition part 60 has a boss 64 protruding from the contact region 61B of the opposing surface 61 toward the board chamber 51 (toward the cover 70). The boss 64 fits into a through hole 46 in the control board 40.

In the exemplary embodiment shown in FIG. 1C, the protrusion length of the boss 64 from the contact region 61B of the opposing surface 61 is greater than the thickness of the printed wiring board 41 of the control board 40. A top portion of the boss 64 thus protrudes through the printed wiring board 41 of the control board 40 toward the cover 70.

In some embodiments, as shown in FIGS. 1A to 1C, the partition part 60 includes a side peripheral wall part 66 disposed along the outer peripheral edge of the partition part 60.

The side peripheral wall part 66 has an inner side surface 66A and an outer side surface 66B. In the exemplary embodiments shown in FIGS. 1A to 1C, the inner side surface 66A of the side peripheral wall part 66 defines the outer peripheral boundary of the board chamber 51. In other words, the inner side surface 66A of the side peripheral wall part 66 forms a part of the inner wall surface of the board chamber 51 (the side surface of the board chamber 51).

In addition, the partition part 60 may have an attachment part 68 overhung radially outward.

The attachment part 68 is used to install the circuit-integrated motor 100. For example, if the circuit-integrated motor 100 is an in-car motor, the circuit-integrated motor 100 may be attached to a vehicle body via the attachment part 68.

The cover 70 is disposed on the opposite side of the control board 40 from the partition part 60. The cover 70, together with the partition part 60, constitutes the casing 50.

In some embodiments, as shown in FIGS. 1A to 1C, the cover 70 includes at least one protrusion 72 protruding toward the board chamber 51. The control board 40 is held in the board chamber 51 between the protrusion 72 of the cover 70 and the contact region 61B of the opposing surface 61 of the partition part 60.

Each protrusion 72 is at a position overlapping with the contact region 61B of the opposing surface 61 of the partition part 60 when viewed from the normal direction of the control board 40 (the axial direction of the circuit-integrated motor 100). In other words, in the axial direction of the circuit-integrated motor 100, when the protrusion 72 of the cover 70 is projected onto the opposing surface 61 of the partition part 60, the area occupied by the protrusion 72 and the contact region 61B overlap at least partially. In the exemplary embodiments shown in FIGS. 1A to 1C, when viewed from the normal direction of the control board 40, each protrusion 72 is wholly encompassed within the corresponding contact region 61B. In another embodiment, when viewed from the normal direction of the control board 40, each protrusion 72 partially protrudes from the corresponding contact region 61B.

In some embodiments, as shown in FIGS. 1A to 1C, the cover 70 includes a cover plate part 74 extending along the control board 40 and at least one hanging part 76 connected to the outer peripheral edge of the cover plate part 74 via a bent portion 75.

The cover plate part 74 extends along the control board 40 on the opposite side of the control board 40 from the partition part 60, and a lower surface 71 of the cover plate part 74 forms a part of the inner wall surface (ceiling surface) of the board chamber 51. The lower surface 71 of the cover plate part 74 includes a non-contact region 71A not in contact with the control board 40 and a contact region 71B in contact with the control board 40. In the embodiments shown in FIGS. 1A to 1C, the protrusion 72 is provided on the cover plate part 74 of the cover 70. The protrusion 72 protrudes into the board chamber 51 from the non-contact region 71A of the lower surface 71 of the cover plate part 74 toward the control board 40. The top surface of the protrusion 72 forms the contact region 71B of the lower surface 71 of the cover plate part 74.

The hanging part 76 is disposed from the bent portion 75 so as to extend downward along the side peripheral wall part 66 of the partition part 60. In the embodiments shown in FIGS. 1A to 1C, the hanging part 76 is disposed along the outer side surface 66B of the side peripheral wall part 66. In other words, the hanging part 76 is located on the opposite side of the side peripheral wall part 66 from the board chamber 51 in the radial direction of the circuit-integrated motor 100. In another embodiment, the hanging part 76 is disposed along the inner side surface 66A of the side peripheral wall part 66.

In some embodiments, as shown in FIGS. 1B and 1C, the lower surface 71 of the cover plate part 74 opposing the control board 40 is at a position higher than the tip end of the protrusion 72 and lower than the upper end of the side peripheral wall part 66 in at least a part of the region (non-contact region 71A) excluding the protrusion 72. Here, in the axial direction of the circuit-integrated motor 100, the direction from the partition part 60 to the cover 70 is defined as upward, and the positional relationship between the lower surface 71 of the cover plate part 74 and the tip end of the protrusion 72 or the upper end of the side peripheral wall part 66 is expressed as “high” or “low”.

In other words, with respect to the non-contact region 61A of the opposing surface 61 of the partition part 60, the height H of the non-contact region 71A of the lower surface 71 of the cover plate part 74 is greater than the height H1 of the tip end position of the protrusion 72 and less than the height H2 of the upper end position of the side peripheral wall part 66, as shown in FIGS. 1B and 1C. In the exemplary embodiments shown in FIGS. 1B and 1C, the relationship of H1 < H < H2 is established by providing a depression 73 in the upper surface (opposite the lower surface 71) of the cover plate part 74 so that the lower surface 71 of the cover plate part 74 approaches the opposing surface 61 of the partition part 60.

In the embodiment shown in FIG. 1C, the protrusion 72 of the cover 70 has a recess 78 formed on the tip end surface of the protrusion 72 (contact region 71B of the lower surface 71 of the cover plate part 74). The recess 78 has a shape complementary to the top portion of the boss 64 protruding from the contact region 61B of the opposing surface 61 of the partition part 60 and is capable of receiving the top portion of the boss 64.

In an embodiment, the recess 78 is formed by a connection hole 79 that connects the inside and outside of the board chamber 51. In the exemplary embodiment shown in FIG. 1C, the connection hole 79 that connects the inside and outside of the board chamber 51 is a through hole that passes axially through the portion of the cover plate part 74 where the protrusion 72 is provided, and with the cover 70 assembled to the partition part 60, the top portion of the boss 64 penetrates halfway through the connection hole 79 (through hole).

The cover 70 with the above configuration is attached to the partition part 60 by any means including fitting or fastening.

In some embodiments, as shown in FIGS. 1A to 1C, the circuit-integrated motor 100 includes a fitting part 80 for the partition part 60 and the cover 70. The fitting part 80 includes at least one fitting claw 82 and a fitting recess 84 capable of engaging with the corresponding fitting claw 82. The fitting claw 82 is disposed on one of the side peripheral wall part 66 and the hanging part 76. On the other hand, the fitting recess 84 is disposed on the other of the side peripheral wall part 66 and the hanging part 76. The fitting recess 84 is formed by a recess or an opening provided on the side peripheral wall part 66 or the hanging part 76.

In the embodiments shown in FIGS. 1A to 1C, the fitting part 80 includes a fitting claw 82 disposed on the outer side surface 66B of the side peripheral wall part 66 and a fitting recess 84 disposed on the hanging part 76. In this case, the fitting claw 82 gradually decreases its protrusion from the outer side surface 66B, from the hanging part 76 to the bent portion 75, in the axial direction of the circuit-integrated motor 100.

In another embodiment, the fitting part 80 includes a fitting claw 82 disposed on the hanging part 76 and a fitting recess 84 disposed on the side peripheral wall part 66. In this case, the fitting claw 82 gradually increases its protrusion from the outer side surface 66B, from the hanging part 76 to the bent portion 75, in the axial direction of the circuit-integrated motor 100.

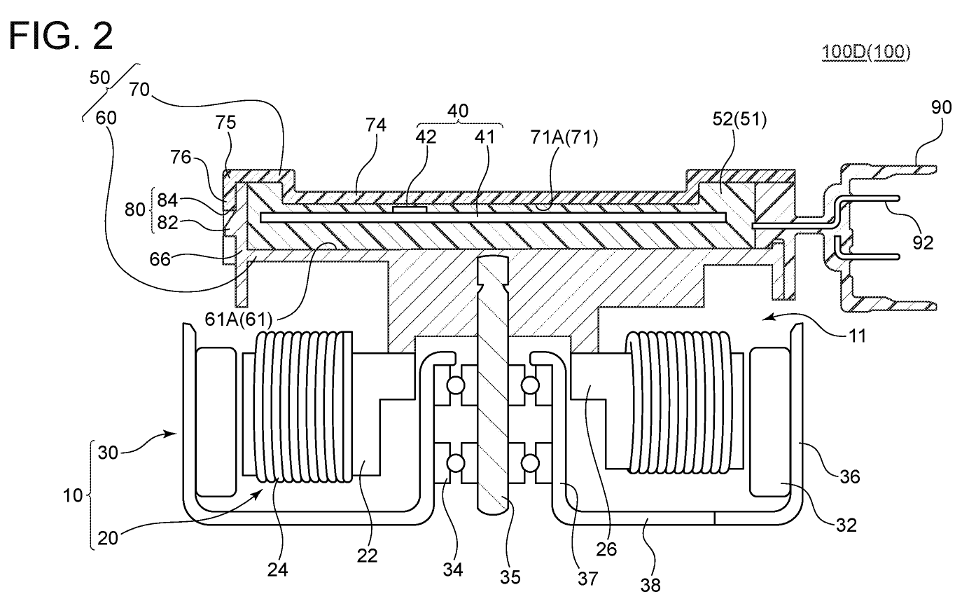

Next, a detailed structure of the circuit-integrated motor 100 according to some embodiments will be described with reference to FIGS. 2 to 6.

In the following, the same reference numerals are used for the parts that are the same as those described above in FIGS. 1A to 1C, and their explanations are omitted as appropriate.

FIG. 2 is a cross-sectional view of a circuit-integrated motor 100D according to an embodiment, taken along its axial direction.

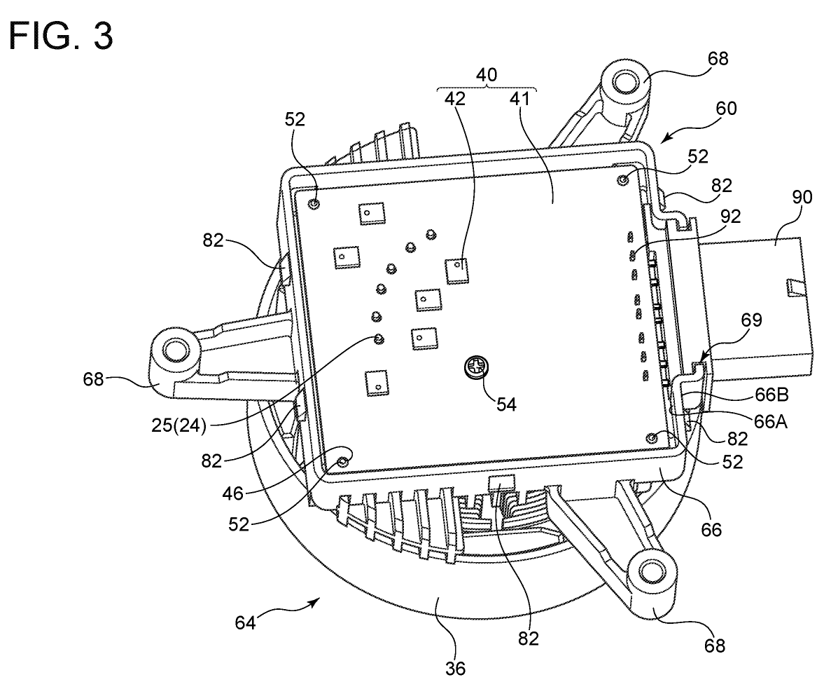

FIG. 3 is a perspective view of the circuit-integrated motor 100D shown in FIG. 2, showing the internal structure of the board chamber 51 with the cover 70 and the sealing resin 55 omitted.

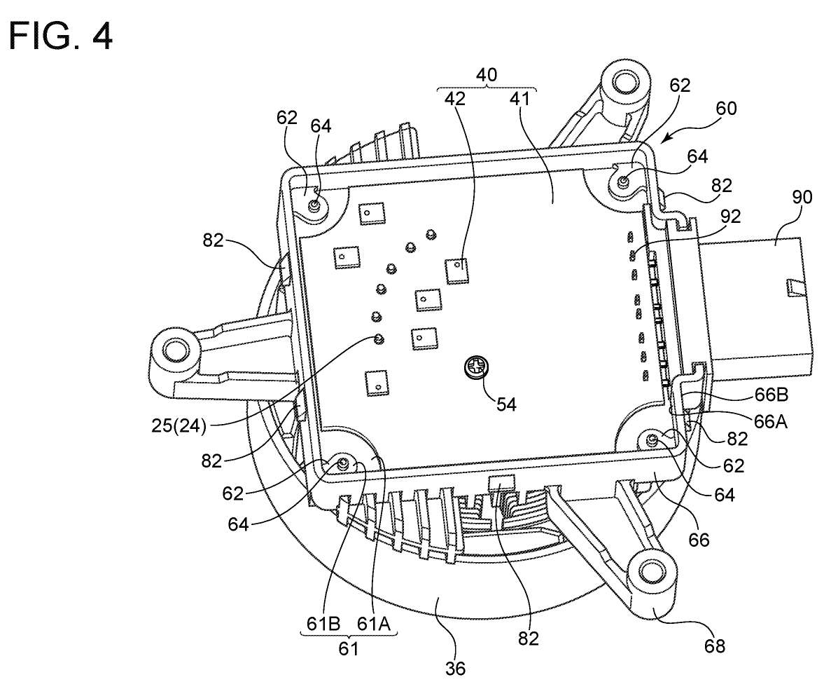

FIG. 4 is a perspective view of the circuit-integrated motor 100D shown in FIG. 2, showing the internal structure of the board chamber 51 with the cover 70, the sealing resin 55, and a part of the control board 40 omitted.

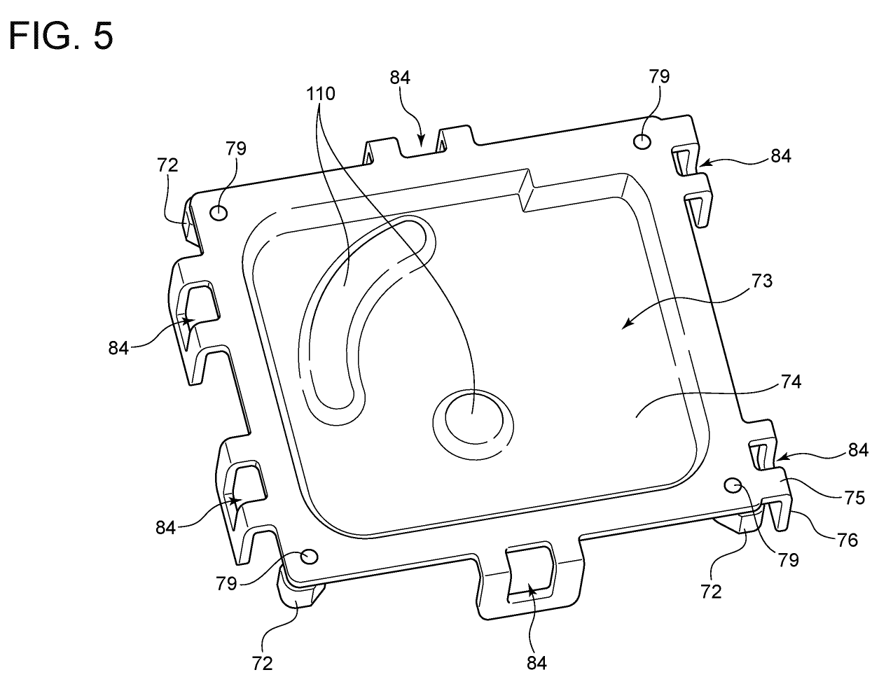

FIG. 5 is a perspective view of the cover 70 of the circuit-integrated motor 100D shown in FIG. 2, showing the cover 70 from above at an angle.

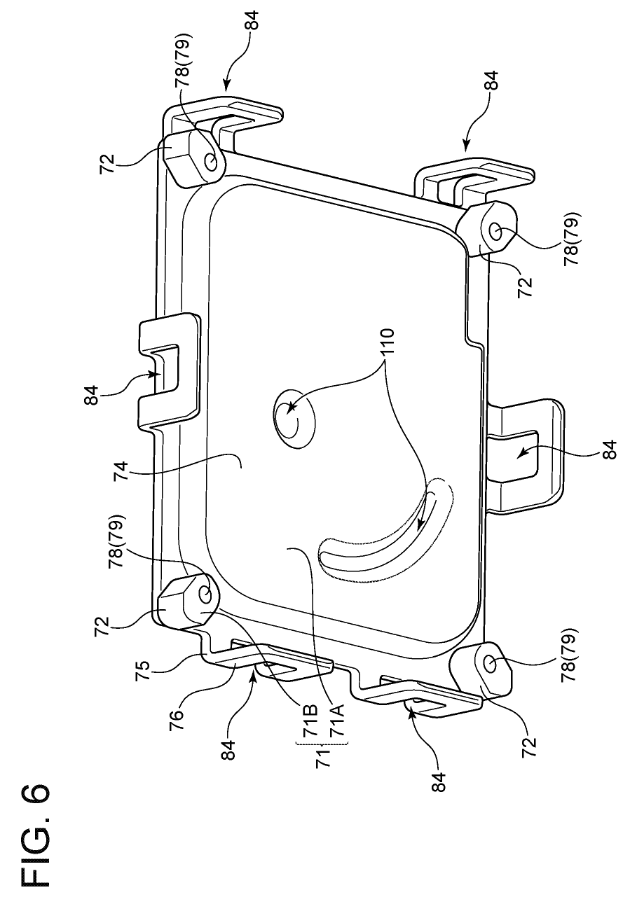

FIG. 6 is a perspective view of the cover 70 of the circuit-integrated motor 100D shown in FIG. 2, showing the cover 70 from below at an angle.

In some embodiments, as shown in FIG. 2, the circuit-integrated motor 100 includes a motor 10, a control board 40 for controlling the motor 10, and a casing 50 having a partition part 60 and a cover 70. The partition part 60 extends along a direction perpendicular to the axial direction so as to divide the board chamber 51 from the motor placement space 11.

As shown in FIGS. 3 and 4, the partition part 60 has a side peripheral wall part 66 that forms a substantially rectangular contour corresponding to the control board 40 in plan view. The side peripheral wall part 66 has a notch 69 in a portion where a terminal holder 90 is provided. The terminal holder 90 has a plurality of terminals 92 for connecting external devices to the control board 40.

In some embodiments, as shown in FIG. 4, the opposing surface 61 of the partition part 60 to the control board 40 includes a non-contact region 61A not in contact with the control board 40 and a contact region 61B in contact with the control board 40.

The contact region 61B is arranged at each of the four corner portions of the substantially rectangular opposing surface 61 surrounded by the side peripheral wall part 66, corresponding to the four corners of the control board 40. The four contact regions 61B of the opposing surface 61 are the top surfaces of rising portions 62 at the four corners of the partition part 60, respectively. The top surface of each rising portion 62 (contact region 61B) is provided with a boss 64 protruding toward the board chamber 51 (toward the cover 70). The boss 64 fits into a through hole 46 (see FIG. 3) in the control board 40, and the top portion of the boss 64 protrudes through the through hole 46 in the control board 40 toward the cover 70. The top portion of the boss 64 is received in a recess 78 (connection hole 79) of the cover 70, described below.

In some embodiments, as shown in FIGS. 3 and 4, the circuit-integrated motor 100 includes a screw 54 that fastens the control board 40 to the partition part 60.

The control board 40 has a ground terminal 44 (see FIGS. 1A to 1C) disposed in a portion that is fastened to the partition part 60 by the screw 54. The ground terminal 44 is pressed against the partition part 60 having conductivity by fastening force of the screw 54 and is electrically connected to the partition part 60.

In some embodiments, as shown in FIGS. 3 and 4, the control board 40 includes six semiconductor devices constituting an inverter circuit as electronic devices 42.

The control board 40 is electrically connected to an end portion 25 of the coil wire 24 of the motor 10. In the exemplary embodiments shown in FIGS. 3 and 4, the six coil ends (end portion of the coil wire 24) 25 are electrically connected to through holes in the printed wiring board 41 of the control board 40.

The control board 40 is electrically connected to a plurality of terminals 92 of the terminal holder 90. In the exemplary embodiments shown in FIGS. 3 and 4, the tip portions of eight terminals 92 are electrically connected to through holes in the printed wiring board 41 of the control board 40.

In some embodiments, as shown in FIGS. 5 and 6, the cover 70 includes a cover plate part 74 extending along the control board 40 and a hanging part 76 connected to the outer peripheral edge of the cover plate part 74 via a bent portion 75.

In the exemplary embodiments shown in FIGS. 5 and 6, one or two hanging parts 76 are provided on each side of the substantially rectangular cover plate part 74. Each hanging part 76 is disposed along the outer side surface 66B of the side peripheral wall part 66, as shown in FIG. 2. Each hanging part 76 has a fitting recess 84 capable of engaging with a fitting claw 82 disposed on the outer side surface 66B of the side peripheral wall part 66 of the partition part 60, and the fitting claw 82 and the fitting recess 84 form a fitting part 80. The fitting recess 84 is an opening provided on the hanging part 76, as shown in FIGS. 5 and 6.

A lower surface 71 of the cover plate part 74 includes a non-contact region 71A not in contact with the control board 40 and a contact region 71B in contact with the control board 40.

In the embodiments shown in FIGS. 5 and 6, the protrusion 72 is provided at each of the four corners of the cover plate part 74 that is substantially rectangular in plan view, and the top surface of each protrusion 72 forms the contact region 71B of the lower surface 71 of the cover plate part 74. On the other hand, the non-contact region 71A is formed by a region of the lower surface 71 of the cover plate part 74 excluding the protrusions 72.

In the exemplary embodiments, as shown in FIG. 5, the cover 70 has a depression 73 on the upper surface (opposite the lower surface 71) of the cover plate part 74. As a result, as shown in FIGS. 2 and 6, the lower surface 71 of the cover plate part 74 is higher than the tip end position of the protrusion 72 and lower than the upper end position of the side peripheral wall part 66 in a part (corresponding to the depression 73) of the region (non-contact region 71A) excluding the protrusions 72.

In some embodiments, as shown in FIGS. 5 and 6, the cover plate part 74 has at least one rising portion 110 in the region where the depression 73 is provided. The rising portion 110 rises in a direction away from the control board 40 with respect to a portion of the depression 73 surrounding the rising portion 110. Therefore, the lower surface 71 of the cover plate part 74 is higher in the rising portion 110 than in a portion of the non-contact region 71A corresponding to the depression 73.

In the exemplary embodiments shown in FIGS. 5 and 6, the rising portion 110 is disposed at a position corresponding to the screw 54 and the end portion 25 of the coil wire 24. The lower surface 71 of the cover plate part 74 is raised upward by the rising portion 110 to avoid interference with the screw 54 and the end portion 25 of the coil wire 24.

The characteristic configurations of the circuit-integrated motor 100 (1A to 1C) according to some embodiments described above are summarized as follows.

[1] A circuit-integrated motor (100; 100A to 100D) according to at least some embodiments of the present invention includes: a motor (10); a control board (40) for controlling the motor (10); and a casing (50) including a partition part (60) dividing a board chamber (51) for housing the control board (40) from a placement space (11) for the motor (10), and a cover (70) disposed on the opposite side of the control board (40) from the partition part (60). An opposing surface (61) of the partition part (60) to the control board (40) includes: a non-contact region (61A) not in contact with the control board (40); and a contact region (61B) rising from the non-contact region (61A) and in contact with the control board (40). The cover (70) has at least one protrusion (72) which protrudes toward the board chamber (51) at a position overlapping with the contact region (61B) of the opposing surface (61) when viewed from the normal direction of the control board (40). The control board (40) is held between the at least one protrusion (72) of the cover (70) and the contact region (61B) of the opposing surface (61) of the partition part (60).

According to the above configuration [1], since the control board (40) can be held and fixed by the protrusion (72) of the cover (70) that covers the control board (40) in the board chamber (51), it is possible to simplify the structure for fixing the control board (40) and reduce the number of man-hours required to assemble the circuit-integrated motor (100; 100A to 100D). Additionally, it is possible to reduce the number of fastening parts used to fix the control board (40) and reduce the number of parts in the circuit-integrated motor (100; 100A to 100D).

[2] In some embodiments, in the above configuration [1], the partition part (60) includes a side peripheral wall part (66) disposed along an outer peripheral edge of the partition part (60). The cover (70) includes: a cover plate part (74) extending along the control board (40) on the opposite side of the control board (40) from the partition part (60) and including the at least one protrusion (72); and at least one hanging part (76) connected to an outer peripheral edge of the cover plate part (74) via a bent portion (75) and extending downward along the side peripheral wall part (66) of the partition part (60). One of the side peripheral wall part (66) and the hanging part (76) has at least one fitting claw (82), and the other of the side peripheral wall part (66) and the hanging part (76) has a fitting recess (84) capable of engaging with the or each fitting claw (82).

According to the above configuration [2], the fitting part (80) including the fitting claw (82) and the fitting recess (84) allows easy assembly of the cover (70). Further, the number of fastening parts to fix the cover (70) can be reduced.

[3] In some embodiments, in the above configuration [2], the hanging part (76) of the cover (70) is disposed along an outer side surface (66B) of the side peripheral wall part (66), and the fitting claw (82) disposed on the outer side surface (66B) of the side peripheral wall part (66) is configured to engage with the fitting recess (84) disposed on the hanging part (76).

According to the above configuration [3], the cover (70) can be attached to the side peripheral wall part (66) by fitting (snap-fit) without affecting the layout of the control board (40) in the board chamber (51).

[4] In some embodiments, in any of the above configurations [1] to [3], the partition part (60) includes a side peripheral wall part (66) disposed along an outer peripheral edge of the partition part (60). The cover (70) includes a cover plate part (74) extending along the control board (40) on the opposite side of the control board (40) from the partition part (60) and including the at least one protrusion (72). The circuit-integrated motor (100; 100B to 100D) includes a sealing resin (52) filled in the board chamber (40) between the cover plate part (74) and the partition part (60). A lower surface (71) of the cover plate part (74) opposing the control board (40) is at a position higher than a tip end of the at least one protrusion (72) and lower than an upper end of the side peripheral wall part (66) in at least a partial region excluding the at least one protrusion (72).

According to the above configuration [4], the amount of the sealing resin (52) used to seal the control board (40) can be reduced by placing at least part of the lower surface (71) of the cover plate part (74) of the cover (70) at a position lower than the upper end of the side peripheral wall part (66).

[5] In some embodiments, in any of the above configurations [1] to [4], the cover (70) includes, as the at least one protrusion (72), four protrusions (72) provided at four corners of the cover (70) corresponding to four corner portions of the control board (40).

According to the above configuration [5], the four protrusions (72) at the four corners of the cover (70) can hold and securely fix the four corner portions of the control board (40).

[6] In some embodiments, in any of the above configurations [1] to [5], the circuit-integrated motor (100; 100A to 100D) includes a screw (54) fastening the control board (40) to the partition part (60). The control board (40) has a ground terminal (44) disposed in a portion that is fastened to the partition part (60) by the screw (54). The ground terminal (44) is pressed against the partition part (60) having conductivity by fastening force of the screw (54) and electrically connected to the partition part (60) having conductivity.

According to the above configuration [6], even when the cover (70) is not attached, it is possible to establish an electrical connection between the ground terminal (44) of the control board (40) and the partition part (60). This allows the operation of the control board (40) to be checked when the cover (70) is not attached.

[7] In some embodiments, in any of the above configurations [1] to [6], the partition part (60) has a boss (64) protruding from the contact region (61B) of the opposing surface (61) toward the cover (70). The control board (40) has a through hole (46) into which the boss (64) fits.

According to the above configuration [7], when assembling the control board (40) to the partition part (60) (or if the board chamber (51) is filled with a sealing resin, when filling it), misalignment of the control board (40) with the partition part (60) can be suppressed.

[8] In some embodiments, in the above configuration [7], the at least one protrusion (72) of the cover (70) has a tip surface having a recess (78) for receiving a top portion of the boss (64).

According to the above configuration [8], since the top portion of the boss (64) disposed on the partition part (60) is received in the recess (78) disposed on the cover (70), the cover (70) can be easily assembled by positioning the cover (70) by the boss (64).

[9] In some embodiments, in the above configuration [8], the circuit-integrated motor (100; 100C, 100D) includes a sealing resin (52) filled in the board chamber (51) between the cover (70) and the partition part (60), and the recess (78) is formed by a connection hole (79) that connects the inside and outside of the board chamber (51).

According to the above configuration [9], when filling the board chamber (51) with the sealing resin (52), air bubbles can be prevented from accumulating in the recess (78) on the cover (70), and the reliability of the circuit integrated motor (100; 100C, 100D) can be improved.

1. A circuit-integrated motor, comprising:
a motor;
a control board for controlling the motor; and
a casing including a partition part dividing a board chamber for housing the control board from a placement space for the motor, and a cover disposed on an opposite side of the control board from the partition part,
an opposing surface of the partition part to the control board including:
a non-contact region not in contact with the control board; and
a contact region rising from the non-contact region and in contact with the control board,
the cover having at least one protrusion which protrudes toward the board chamber at a position overlapping with the contact region of the opposing surface when viewed from a normal direction of the control board,
the control board being held between the at least one protrusion of the cover and the contact region of the opposing surface of the partition part.

2. The circuit-integrated motor according to claim 1, wherein
the partition part includes a side peripheral wall part disposed along an outer peripheral edge of the partition part,
the cover includes:
a cover plate part extending along the control board on the opposite side of the control board from the partition part and including the at least one protrusion; and
at least one hanging part connected to an outer peripheral edge of the cover plate part via a bent portion and extending downward along the side peripheral wall part of the partition part,
one of the side peripheral wall part and the hanging part has at least one fitting claw, and
the other of the side peripheral wall part and the hanging part has a fitting recess capable of engaging with the or each fitting claw.

3. The circuit-integrated motor according to claim 2, wherein
the hanging part of the cover is disposed along an outer side surface of the side peripheral wall part, and
the fitting claw disposed on the outer side surface of the side peripheral wall part is configured to engage with the fitting recess disposed on the hanging part.

4. The circuit-integrated motor according to claim 1, wherein
the partition part includes a side peripheral wall part disposed along an outer peripheral edge of the partition part,
the cover includes a cover plate part extending along the control board on the opposite side of the control board from the partition part and including the at least one protrusion,
the circuit-integrated motor comprises a sealing resin filled in the board chamber between the cover plate part and the partition part, and
a lower surface of the cover plate part opposing the control board is at a position higher than a tip end of the at least one protrusion and lower than an upper end of the side peripheral wall part in at least a partial region excluding the at least one protrusion.

5. The circuit-integrated motor according to claim 1, wherein
the cover includes, as the at least one protrusion, four protrusions provided at four corners of the cover corresponding to four corner portions of the control board.

6. The circuit-integrated motor according to claim 1, comprising a screw fastening the control board to the partition part, wherein
the control board has a ground terminal disposed in a portion that is fastened to the partition part by the screw, and
the ground terminal is pressed against the partition part having conductivity by fastening force of the screw and electrically connected to the partition part having conductivity.

7. The circuit-integrated motor according to claim 1, wherein
the partition part has a boss protruding from the contact region of the opposing surface toward the cover, and
the control board has a through hole into which the boss fits.

8. The circuit-integrated motor according to claim 7, wherein
the at least one protrusion of the cover has a tip surface having a recess for receiving a top portion of the boss.

9. The circuit-integrated motor according to claim 8, comprising a sealing resin filled in the board chamber between the cover and the partition part, wherein
the recess is formed by a connection hole that connects inside and outside of the board chamber.
